(19) United States
(12) Patent Application Publication
(10) Pub. No.: US 2003/0162071 A1
(43) Pub. Date: Aug. 28, 2003

(54) Actuator device for force-feeding air, and air force-feed type air cell

(76) Inventor: Hisafumi Yasuda, Tokyo (JP)

Correspondence Address: NIXON PEABODY, LLP, 8180 GREENSBORO DRIVE, SUITE 800, MCLEAN, VA, 22102, US

(21) Appl. No.: 10/258,139

(22) PCT Filed: Feb. 21, 2002
(86) PCT No.: PCT/JP02/01505

(30) Foreign Application Priority Data
Feb. 21, 2001 (JP) 2001-45804

(51) Int. Cl. H01M 8/04; F04B 39/08

(52) U.S. Cl. 429/34; 417/505

(57) ABSTRACT

An actuator device for forced air supply comprises two diaphragms 8 and 9 facing each other, voice coils 6 and 7 attached onto surfaces of the respective diaphragms 8 and 9, a magnet 2 integral with pole pieces 3 and 4, a yoke 5 facing the pole pieces 3 and 4, and a housing 1 hermetically holding a relative space between the diaphragms 8 and 9, and is structured as an air pump by means of the two diagrams 8 and 9 which oscillate repetitively and continuously by providing an air inlet 16 and an air outlet 17 which lead to the relative space between the diaphragms 8 and 9 and providing an on-off valve 18 on the inside corresponding to the air inlet 16 and an on-off valve 19 on the outside corresponding to the air outlet 19.

### TECHNICAL FIELD

The present invention relates to an actuator device for forced air supply and a forced air supply-type air cell.

### BACKGROUND ART

An air cell is generally known as a primary battery which uses an activated carbon electrode and zinc as an anode and a cathode respectively and uses air as an anode active material. The air cell is intended to be mounted as a battery in portable information equipment such as a cellular phone and an electronic pocketbook. Moreover, to mount this air cell, the provision of a forced air supply means is under study. It is assumed that an existing small-sized fan motor is provided as the forced air supply means. However, the existing small-sized fan motor is expensive, and has problems of vibration and noise since its fan operates by a bearing such as a ball bearing or an oilless metal.

### DISCLOSURE OF THE INVENTION

An object of the present invention is to provide an actuator device for forced air supply which is inexpensive and capable of supplying air efficiently without causing vibration and noise.

Another object of the present invention is to provide a forced air supply-type air cell including an actuator device for forced air supply which is inexpensive and capable of supplying air efficiently without causing vibration and noise.

An actuator device for forced air supply according to the present invention comprises: two diaphragms facing each other with a space therebetween; voice coils attached onto surfaces of the respective diaphragms; a magnet integrally provided with pole pieces; a yoke facing the pole pieces with magnetic gaps therebetween; and a housing hermetically holding the relative space between the diaphragms, the actuator device for forced air supply being structured as an air pump by means of repetitive and continuous oscillations of the diaphragms by forming magnetic circuits by inserting the voice coils of the respective diaphragms into the magnetic gaps between the pole pieces and the yoke and providing current-carrying circuits of the voice coils to allow the two diaphragms to oscillate repetitively and continuously, providing an air inlet and an air outlet which lead to the relative space between the diaphragms, and providing an on-off valve on the inside corresponding to the air inlet and an on-off valve on the outside corresponding to the air outlet.

In the actuator device for forced air supply according to the present invention, the actuator device for forced air supply is structured as the air pump by means of repetitive and continuous oscillations of the diaphragms by forming the magnetic circuits by making the cylindrical housing a base frame, placing the magnet integrally provided with the pole pieces in the middle within the frame of the housing, mounting the yoke which faces the pole pieces from outside with the magnetic gaps therebetween within the frame of the housing, tensely providing the two diaphragms with the voice coils attached to their inner surface sides to face each other within the frame at open ends of the housing, and inserting the voice coils of the respective diaphragms into the magnetic gaps between the pole pieces and the yoke and providing the current-carrying circuits of the voice coils to allow the two diaphragms to oscillate repetitively and continuously, providing the air inlet and the air outlet in the housing, and providing the on-off valve on the inside of the housing corresponding to the air inlet and the on-off valve on the outside of the housing corresponding to the air outlet.

In the actuator device for forced air supply according to the present invention, the actuator device for forced air supply is structured as the air pump by means of repetitive and continuous oscillations of the diaphragms by forming the magnetic circuits by making the cylindrical housing a base frame, placing the magnet integrally provided with the pole pieces in the middle within the frame of the housing, mounting the yoke which faces the pole pieces from outside with the magnetic gaps therebetween within the frame of the housing, tensely providing the two diaphragms with the voice coils attached to their inner surface sides to face each other within the frame at open ends of the housing, and inserting the voice coils of the respective diaphragms into the magnetic gaps between the pole pieces and the yoke and providing the current-carrying circuits of the voice coils to allow the two diaphragms to oscillate repetitively and continuously, providing the air inlet and outlet at the centers of the surfaces of the diagrams respectively, and providing the on-off valve on the inside of one of the diaphragms corresponding to the air inlet and the on-off valve on the outside of the other of the diaphragms corresponding to the air outlet.

In the actuator device for forced air supply according to the present invention, the magnetic circuits for the respective voice coils are formed by one magnet provided with the pole piece on either side and one yoke facing each of the pole pieces.

In the actuator device for forced air supply according to the present invention, the magnetic circuits for the respective voice coils are formed by two magnets each provided with the pole piece on one side and two yokes facing the pole pieces individually.

In the actuator device for forced air supply according to the present invention, the actuator device for forced air supply is structured as the air pump by means of repetitive and continuous oscillations of the diaphragms by forming the magnetic circuits by tensely providing the two diaphragms with the voice coils mounted on their outer surface sides to face each other within the housing, providing the magnets each provided with the pole piece on one side and the yokes which face the pole pieces with the magnetic gaps therebetween respectively on the outside of each of the diaphragms on both sides of the housing, and inserting the voice coils of the diaphragms into the magnetic gaps between the pole pieces and the yokes respectively and providing the current-carrying circuits of the voice coils to allow the two diaphragms to oscillate repetitively and continuously, providing the air inlet and outlet in the housing, and providing the on-off valve on the inside of the housing corresponding to the air inlet and the on-off valve on the outside of the housing corresponding to the air outlet.

A forced air supply-type air cell according to present invention is structured including any one of the actuator devices for forced air supply described above.

### BRIEF DESCRIPTION OF DRAWINGS

FIG. 1 is an explanatory view showing the structure of an actuator device for forced air supply according to an embodiment of the present invention in section;

FIG. 2 is an explanatory view showing the structure of the actuator device for forced air supply in plan;

FIG. 3 is a plan view showing an on-off valve as an example which is provided in the actuator device for forced air supply;

FIG. 4 is a plan view showing an on-off valve as another example which is provided in the actuator device for forced air supply;

FIG. 5 is an explanatory view showing the leaving motion by expansion of diaphragms provided in the actuator device for forced air supply;

FIG. 6 is an explanatory view showing the returning motion by approach of the diaphragms provided in the actuator device for forced air supply;

FIG. 7 is an explanatory view showing the structure of the actuator device for forced air supply provided with an air path different from that in the embodiment in FIG. 1 in section;

FIG. 8 is an explanatory view showing the structure of an actuator device for forced air supply according to an embodiment different from that in FIG. 1 of the present invention in section;

FIG. 9 is a plan view showing the actuator device for forced air supply in FIG. 8;

FIG. 10 is an explanatory view showing the structure of an actuator device for forced air supply according to an embodiment different from those in FIG. 1 and FIG. 8 of the present invention in section; and

FIG. 11 is an explanatory view showing the structure of an actuator device for forced air supply according to an embodiment different from those in FIGS. 1, 8, and 10 of the present invention in section.

### BEST MODE FOR CARRYING OUT THE INVENTION

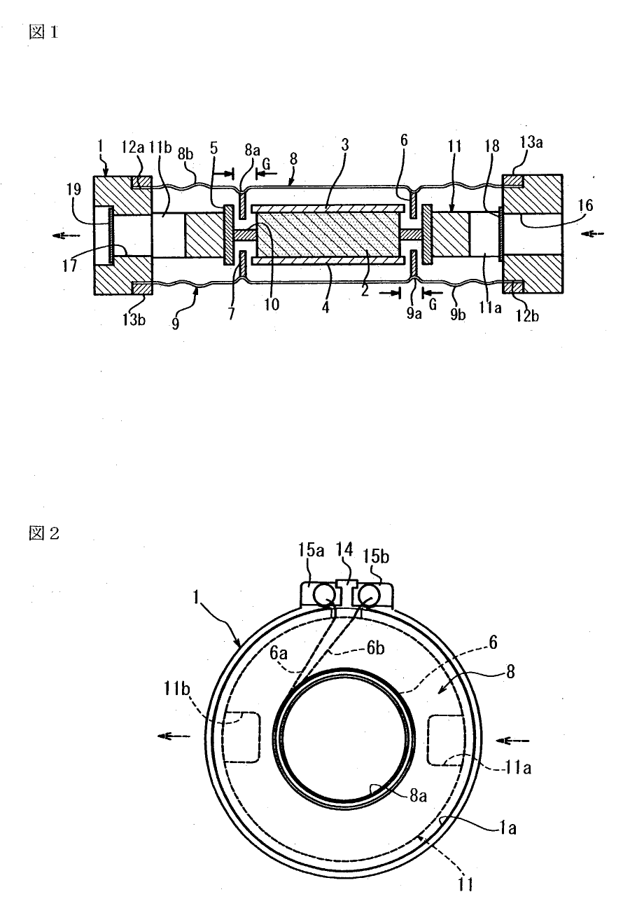

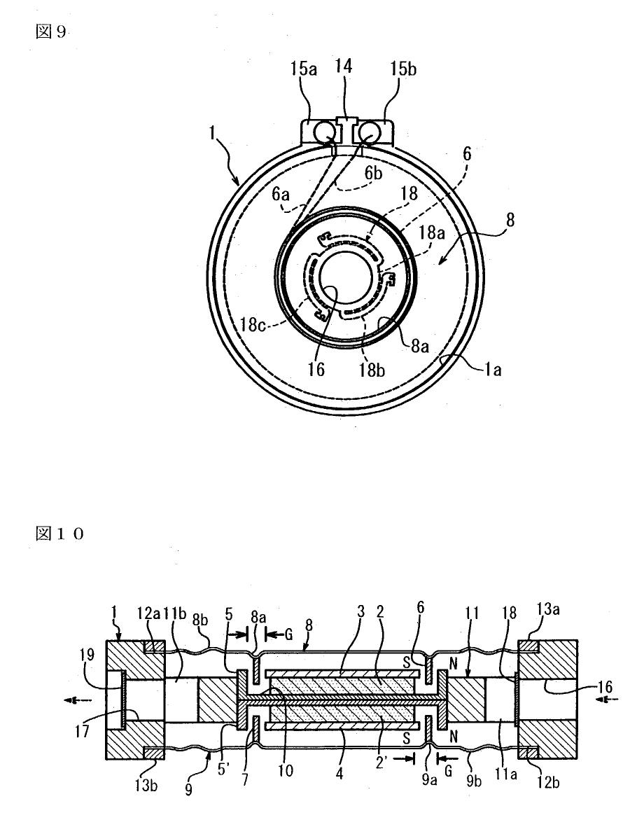

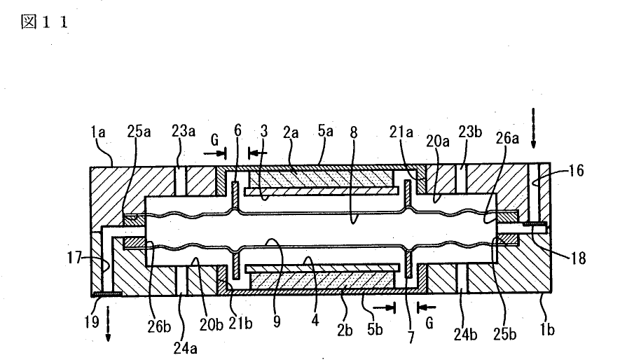

Giving explanation below with reference to the attached drawings, each of illustrated embodiments is structured as an electromagnetic induction-type actuator device for forced air supply provided in an air cell in which air is used as an anode active material. When the embodiments are broadly divided, an embodiment shown in FIG. 1, an embodiment shown in FIG. 8, an embodiment shown in FIG. 10, and an embodiment shown in FIG. 10 are enumerated. Out of these, the embodiments shown in FIGS. 1, 8, and 10 are each structured to be a magnetic circuit built-in type, and the embodiment shown in FIG. 11 is structured to be a diaphragm built-in type. Incidentally, components common to respective embodiments are shown using the same numerals and symbols.

The common aspect of the embodiments is structured as an air pump by means of double diaphragms which perform repetitive and continuous oscillations (leaving motion by expansion and returning motion by approach) by making a cylindrical housing 1 (1a, 1b) a basic frame, forming magnetic circuits by a magnet 2 (2a, 2b), pole pieces 3 and 4, a yoke 5 (5a, 5b), inserting voice coils 6 and 7 in magnetic gaps G between the pole pieces 3 and 4 and the yoke 5 (5a, 5b) respectively, and tensely holding two diaphragms 8 and 9, which face each other with a space therebetween, by the housing 1 to provide current-carrying circuits of the voice coils 6 and 7.

In the embodiment shown in FIG. 1, one disk-shaped magnet 2 is provided, and the pole pieces 3 and 4 are fixedly attached on both sides with the one magnet 2 therebetween. The magnet 2, integrally provided with the pole pieces 3 and 4, is placed in the middle within the frame of the housing 1. As the yoke 5, one cylindrical magnetic ring is provided within the frame of the housing 1 in such a manner to face each of the pole pieces 3 and 4 from outside with the magnetic gap G therebetween.

The magnet 2 and the yoke 5 are fixedly coupled to each other integrally by a resinous bridging plate 10 which bridges a space between both of them. Moreover, the yoke 5 is provided with a resinous supporting plate 11 which is laid between the yoke 5 and the housing 1, and the magnet 2 integrally with the pole pieces 3 and 4, which includes the yoke 5, is fixedly held within the frame of the housing 1 by the supporting plate 11.

Each of the diaphragms 8 and 9 is resinous and thin plate-shaped, which is flexible and deformable. Close to the centers of respective surfaces of the diaphragms, annular recessed portions 8a an 9a are provided such that the voice coils 6 and 7 are each attached to the inner surface side. Further, close to the outer peripheries of the respective surfaces, the concentric corrugated portions 8b and 9b which permit synchronous oscillations are expandably and contractibly provided.

Outer peripheral edges of the diaphragms 8 and 9 are put on step portions 12a and 12b provided along inner peripheral edges at open ends of the housing 1, and fixed by pressing in fitting rings 13a and 13b, whereby the diaphragms are tensely held so as to face each other hermetically within the frame of the housing 1. Moreover, the voice coils 6 and 7 are mounted in such a manner to protrude from the diaphragms 8 and 9 to be inserted in the magnetic gaps G between the pole pieces 3 and 4 and the yoke 5, respectively.

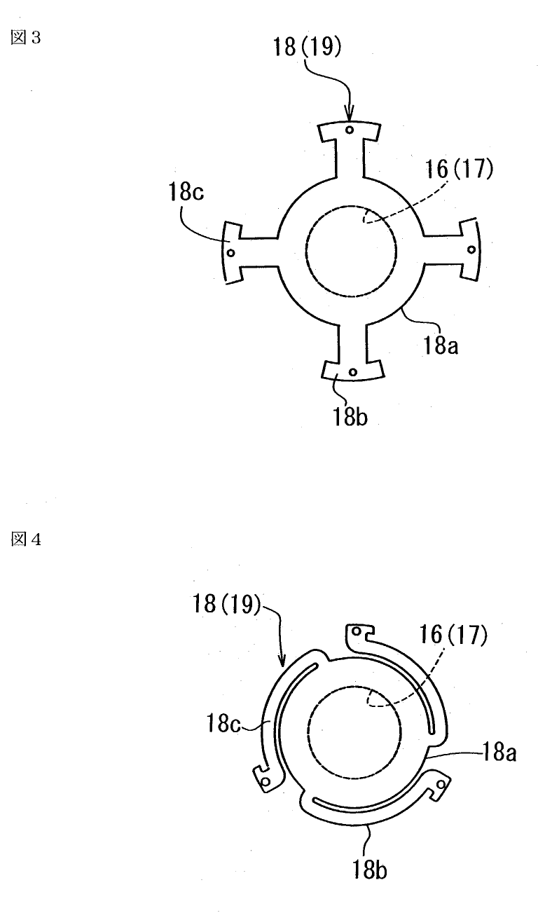

In the above structure, magnetic circuits are formed by the magnet 2, the pole pieces 3 and 4, and the yoke 5. Furthermore, as shown in FIG. 2, leads 6a and 6b of the voice coils 6 and 7 (only the numeral 6 is shown) are drawn out of the housing 1 and connected to terminal fittings 15a and 15b attached to a terminal board 14 of the housing 1 either in each of the coils or after joining positive and negative poles of the respective coils to thereby provide current-carrying circuits.

Depending on the circuit structure, the circuit is designed such that the space between the pole piece 3 and the yoke 5 and the space between the pole piece 4 and the yoke 5 with the voice coils 6 and 7 therebetween respectively show opposing poles, that is, the North Pole and the South Pole, and vice versa (See FIG. 1). By this circuit structure of the electromagnetic induction-type actuator, the diaphragms 8 and 9 are mounted so as to synchronously perform repetitive and continuous oscillations.

In order to apply this actuator function to an air pump, in the embodiment shown in FIG. 1, air inlet 16 and outlet 17 are provided in a side surface of the housing 1 to allow the inside of the frame to communicate with the outside thereof. An on-off valve 18 is provided on the inside of the housing 1, corresponding to the air inlet 16. An on-off valve 19 is provided on the outside of the housing 1, correspond to the air outlet 17.

One or plural air inlets 16 are provided at regular intervals in a circumferential direction of the housing 1. One or plural air outlets 17 are provided adjacent to one another in a direction of air blow. When one air outlet 17 is provided, it may be provided as a circular hole or a long hole lengthened vertically or horizontally. Incidentally, as shown in FIG. 2, corresponding to the air inlet 16 and outlet 17, notches 11a and 11b which form an air flow path are provided at the circumferential edge of the supporting plate 11.

As shown in FIG. 3, the on-off valve 18 (19) is provided with a valve element which has a shielding portion 18a with a wider area than the air inlet 16 and the air outlet 17 and plural supporting arms 18b, 18c . . . extending outward from the perimeter of the shielding portion 18a. This on-off valve 18 (19) is attached by fixing respective tip portions of the supporting arms 18b, 18c . . . to a wall surface of the housing 1.

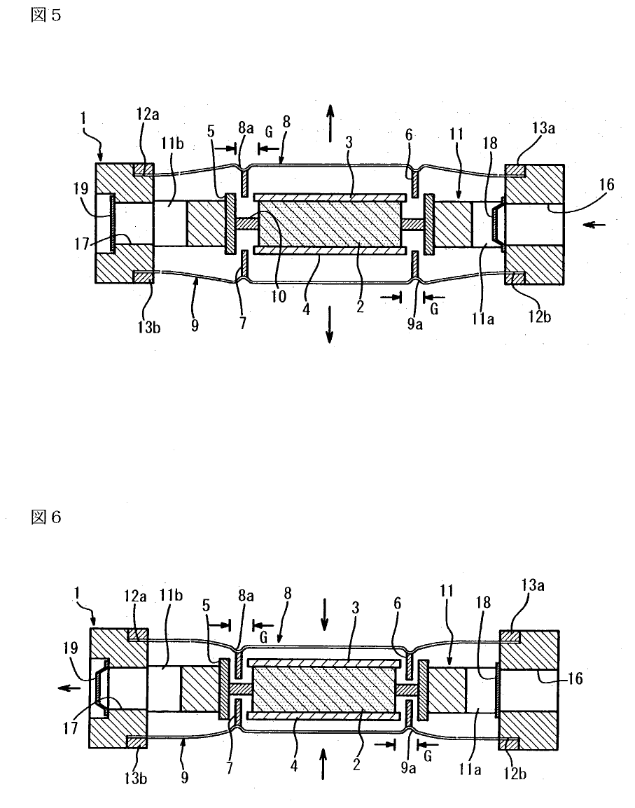

Besides the above on-off valve 18 (19), as shown in FIG. 4, one provided with the supporting arms 18b, 18c . . . whose portions from roots at the shielding portion 18a to tips extend in the circumferential direction of the shielding portion 18a may be provided. In this on-off valve 18 (19), the valve element can be formed compactly, whereby a stroke in an open state can be set large.

When the actuator device for forced air supply thus structured is actuated by the application of an electric current, the diaphragms 8 and 9 oscillate repetitively and continuously in synchronization with each other. When the diaphragms 8 and 9 oscillate in an expanding direction, as shown in FIG. 5, the on-off valve 18 opens and the on-off valve 19 shuts, whereby air flows into the frame of the housing 1 from the air inlet 16.

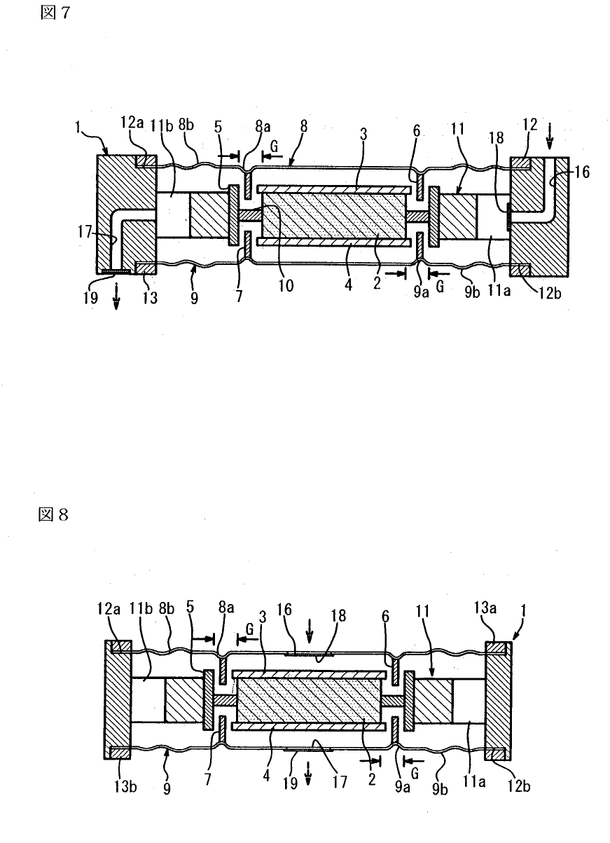

Meanwhile, when the diaphragms 8 and 9 oscillate in an approaching direction, as shown in FIG. 6, the on-off valve 18 shuts and the on-off valve 19 opens, whereby air flows out of the frame of the housing 1 from the outlet 17. By repeating the oscillations of the diaphragms 8 and 9 repetitively and continuously, the actuator device operates as an air pump, and hence, if air is fed from the air outlet 17 to an air cell, the air cell can generate electric energy with the air as an anode active material.

Since the actuator device for forced air supply is structured as an electromagnetic induction-type actuator, it can be structured at lower cost as compared with a fan motor. Moreover, it does not include a rotating mechanism by means of a bearing such as a ball bearing or an oilless bearing, whereby there are no problems of vibration and noise. Especially, the generation of vibration is suppressed by a double diaphragm structure in which the two diaphragms 8 and 9 are provided and oscillated.

In addition to the above, even if the two diaphragms 8 and 9 are provided, the actuator device can be structured inexpensively with the small number of parts since the magnetic circuits are formed by one magnet 2 provided with the pole pieces 3 and 4 on both sides, respectively, and one yoke 5 facing each of the pole pieces 3 and 4 from outside.

In the embodiment shown in FIG. 7, the air inlet 16 and outlet 17 are provided in a thickness surface of the housing 1 to allow the inside of the frame to communicate with the outside thereof. In this embodiment, the design of the air inlet side and outlet side can be changed so that they are provided in different thickness surfaces or the same thickness surface of the housing 1, or one is provided in the side surface of the housing 1 and the other is provided in the thickness surface of the housing 1.

In the embodiment shown in FIG. 8 and FIG. 9, the air inlet 16 and the air outlet 17 are provided separately in the centers of the surfaces of the diaphragms 8 and 9. Moreover, the on-off valve 18 is provided on the inside of the diaphragm 8 corresponding to the air inlet 16, and the on-off valve 19 is provided on the outside of the diaphragm 9 corresponding to the air outlet 17. Components other than the above components are structured similarly to those in the aforementioned embodiments.

In the embodiment shown in FIG. 8 and FIG. 9, the housing 1 shaped into a simple cylinder is provided and air can be directly taken into and out of the diaphragms 8 and 9, whereby air can be supplied rapidly. Moreover, including the embodiment shown in FIGS. 1 and FIG. 7, the aforementioned embodiments can be attached to an air cell or equipment body by properly selecting either one of the air inlet side or the air outlet side according to the installation position of the air cell, the design of the equipment body, and so on.

In the embodiment shown in FIG. 10, two magnets 2a and 2b with the pole pieces 3 and 4 which are attached to only one side respectively are provided, and the magnets 2a and 2b are respectively sandwiched between dish-shaped yokes 5a and 5b and the pole pieces 3 and 4 and joined into one piece, whereby magnetic circuits are formed individually corresponding to the voice coils 6 and 7 of the diaphragms 8 and 9. Components other than the above components are structured similarly to those in the aforementioned embodiments.

In the embodiment shown in FIG. 10, the magnetic circuits operate on the voiced coils 6 and 7 individually, whereby the diaphragms 8 and 9 can be greatly oscillated instantaneously, leading to an increase in the supply quantity of air.

In the embodiment shown in FIG. 11, two dividedly formed housings 1a and 1b are provided, and two diaphragms 8 and 9 with the voice coils 6 and 7 mounted on their outer surface sides respectively are tensely provided facing each other inside the housings 1a and 1b, and the magnets 2a and 2b with the pole pieces 3 and 4 which are attached to only one side respectively and the dish-shaped yokes 5a and 5b which face the pole pieces 3 and 4 respectively with the magnetic gaps G therebetween are mounted on both sides of the housing 1a and 1b on the outside of the respective diaphragms, whereby the actuator device is structured to be a built-in type in which the diaphragms 8 and 9 are contained.

In the above structure, in the housings 1a and 1b, recessed portions 20a and 20b are provided on the inside facing each other, opening portions 21a and 21b are provided in the middle of the recessed portions 20a and 20b, and plural air holes 23a, 23b, 24a, and 24b leading to inner portions of the recessed portions 20a and 20b are provided.

Outer peripheral edges of the diaphragms 8 and 9 are put on step portions 25a and 25b provided along inner peripheral edges of the recessed portions 20a and 20b, and fixed by pressing in fitting rings 26a and 26b, whereby the diaphragms 8 and 9 are tensely held so as to face each other hermetically within the recessed portions 20a and 20b of the housings 1a and 1b. These diaphragms 8 and 9 are provided to be oscillatable table by the air holes 23a, 23b, 24a, and 24b leading to the inner portions of the recessed portions 20a and 20b.

The magnets 2a and 2b with the pole pieces 3 and 4 which attached to only one side respectively are fixedly attached to the inside of the dishes of the yokes 5a and 5b, and the yokes 5a and 5b are fit into the inner sides of the opening portions 21a and 21b to be fixedly attached to the housings 1a and 1b respectively.

Also in this embodiment, magnetic circuits are formed by inserting the voice coils 6 and 7 of the diaphragms 8 and 9 into the magnetic gaps G between the pole pieces 3 and 4 and the yokes 5a and 5b respectively, and leads (not shown) of the voice coils 6 and 7 are drawn out of the housings 1a and 1b and connected to terminal fittings (not shown) to provide current-carrying circuits.

In this embodiment, the air inlet 16 and outlet 17 are provided in the housings, and the on-off valve 18 is provided on the inside of the housing 1a corresponding to the air inlet 16, and the on-off valve 19 is provided on the outside of the housing 1b corresponding to the air outlet 17, whereby similarly to the aforementioned embodiments, the actuator device is structured as an air pump by means of the repetitive and continuous oscillations of the diaphragms 8 and 9.

In the embodiment shown in FIG. 11, the magnetic circuits operate on the voice coils 6 and 7 individually, whereby the diaphragms 8 and 9 can be greatly oscillated instantaneously, and a relative space between the diaphragms 8 and 9 can be made wide, and hence a large quantity of air can be supplied at a time.

In any of the aforementioned embodiments, since the actuator device can be structured inexpensively without the problems of vibration and noise, it can be mounted to an air cell as a preferable applied example. In the case of the air cell, the energy capacity of the air cell is detected by a sensor, and when the energy capacity reduces, the actuator device for forced air supply is actuated by the air cell itself to generate electric energy.

The air cell is, however, the preferable applied example, and in addition to this, the present invention can be extensively applied to whatever requires the supply of air, for the purpose of forced air supply.

### INDUSTRIAL AVAILABILITY

As described above, according to an actuator device for forced air supply according to the present invention, the actuator device for forced air supply comprises: two diaphragms facing each other with a space therebetween; voice coils attached onto surfaces of the respective diaphragms; a magnet integrally provided with pole pieces; a yoke facing the pole pieces with magnetic gaps therebetween; and a housing hermetically holding the relative space between the diaphragms, and is structured to be able to forcedly supply air as an electromagnetic induction-type actuator by means of the two diaphragms by forming magnetic circuits by inserting the voice coils of the respective diaphragms into the magnetic gaps between the pole pieces and the yoke and providing current-carrying circuits of the voice coils to allow the two diaphragms to oscillate repetitively and continuously, providing an air inlet and an air outlet which lead to the relative space between the diaphragms, and providing an on-off valve on the inside corresponding to the air inlet and an on-off valve on the outside corresponding to the air outlet, whereby the actuator device can be structured inexpensively without problems of vibration and noise.

According to the actuator device for forced air supply according to the present invention, the actuator device for forced air supply is structured to be able to take air into and out of the housing as the air pump by means of repetitive and continuous oscillations of the diaphragms by providing the air inlet and outlet in the housing, and providing the on-off valve on the inside of the housing corresponding to the air inlet and the on-off valve on the outside of the housing corresponding to the air outlet, whereby the actuator device can be structured inexpensively without problems of vibration and noise.

According to the actuator device for forced air supply according to the present invention, the actuator device for forced air supply is structured to be able to take air into and out of the diaphragms as the air pump by means of repetitive and continuous oscillations of the diaphragms by providing the air inlet and outlet at the centers of the surfaces of the diagrams respectively, and providing the on-off valve on the inside of one of the diaphragms corresponding to the air inlet and the on-off valve on the outside of the other of the diaphragms corresponding to the air outlet, and consequently, the actuator device can supply air rapidly by taking air directly into and out of the diaphragms and be structured inexpensively without problems of vibration and noise.

According to the actuator device for forced air supply according to the present invention, the magnetic circuits for the respective voice coils are formed by one magnet provided with the pole piece on either side and one yoke facing each of the pole pieces, and hence the actuator device can be structured more inexpensively with the small number of parts.

According to the actuator device for forced air supply according to the present invention, the magnetic circuits for the respective voice coils are formed by two magnets each provided with the pole piece on one side and two yokes facing the pole pieces individually, and the magnetic circuits operate on the voice coils individually, whereby the diaphragms can be greatly oscillated instantaneously, leading to an increase in the supply quantity of air.

According to the actuator device for forced air supply according to the present invention, the actuator device for forced air supply is structured as the air pump by means of repetitive and continuous oscillations of the diaphragms by forming the magnetic circuits by tensely providing the two diaphragms with the voice coils mounted on their outer surface sides respectively to face each other within the housing, providing the magnets each provided with the pole piece on one side and the yokes which face the pole pieces with the magnetic gaps therebetween respectively on the outside of each of the diaphragms on both sides of the housing, and inserting the voice coils of the diaphragms into the magnetic gaps between the pole pieces and the yokes respectively and providing the current-carrying circuits of the voice coils to allow the two diaphragms to oscillate repetitively and continuously, providing the air inlet and outlet in the housing, and providing the on-off valve on the inside of the housing corresponding to the air inlet and the on-off valve on the outside of the housing corresponding to the air outlet, and consequently the magnetic circuits can operate on the voice coils individually, which makes it possible to greatly oscillate the diaphragms instantaneously, and the relative space between the diaphragms can be made wide, whereby the actuator device can supply a large quantity of air at a time, and be structured inexpensively without problems of vibration and noise.

According to a forced air supply-type air cell according to present invention, the forced air supply-type air cell includes any one of the actuator devices for forced air supply described above, whereby the air cell can be structured as an inexpensive air cell without problems of vibration and noise.

1. An actuator device for forced air supply, comprising:
two diaphragms facing each other with a space therebetween;
voice coils attached onto surfaces of said respective diaphragms;
a magnet integrally provided with pole pieces;
a yoke facing the pole pieces with magnetic gaps therebetween; and
a housing hermetically holding the relative space between said diaphragms,
wherein said actuator device for forced air supply is structured as an air pump by means of repetitive and continuous oscillations of said diaphragms by forming magnetic circuits by inserting said voice coils of said respective diaphragms into the magnetic gaps between the pole pieces and said yoke and providing current-carrying circuits of said voice coils to allow said two diaphragms to oscillate repetitively and continuously, providing an air inlet and an air outlet which lead to the relative space between said diaphragms, and providing an on-off valve on the inside corresponding to the air inlet and an on-off valve on the outside corresponding to the air outlet.

2. The actuator device for forced air supply according to claim 1,
wherein said actuator device for forced air supply is structured as the air pump by means of repetitive and continuous oscillations of said diaphragms by forming the magnetic circuits by making said cylindrical housing a base frame, placing said magnet integrally provided with the pole pieces in the middle within the frame of said housing, mounting said yoke which faces the pole pieces from outside with the magnetic gaps therebetween within the frame of said housing, tensely providing said two diaphragms with said voice coils attached to their inner surface sides to face each other within the frame at open ends of said housing, and inserting said voice coils of said respective diaphragms into the magnetic gaps between the pole pieces and said yoke and providing the current-carrying circuits of said voice coils to allow said two diaphragms to oscillate repetitively and continuously, providing the air inlet and the air outlet in said housing, and providing the on-off valve on the inside of said housing corresponding to the air inlet and the on-off valve on the outside of said housing corresponding to the air outlet.

3. The actuator device for forced air supply according to claim 1,
wherein said actuator device for forced air supply is structured as the air pump by means of repetitive and continuous oscillations of said diaphragms by forming the magnetic circuits by making said cylindrical housing a base frame, placing said magnet integrally provided with the pole pieces in the middle within the frame of said housing, mounting said yoke which faces the pole pieces from outside with the magnetic gaps therebetween within the frame of said housing, tensely providing said two diaphragms with said voice coils attached to their inner surface sides to face each other within the frame at open ends of said housing, and inserting said voice coils of said respective diaphragms into the magnetic gaps between the pole pieces and said yoke and providing the current-carrying circuits of said voice coils to allow said two diaphragms to oscillate repetitively and continuously, providing the air inlet and outlet at the centers of the surfaces of said diagrams respectively, and providing the on-off valve on the inside of one of said diaphragms corresponding to the air inlet and the on-off valve on the outside of the other of said diaphragms corresponding to the air outlet.

4. The actuator device for forced air supply according to claim 2 or 3,
wherein the magnetic circuits for said respective voice coils are formed by one magnet provided with the pole piece on either side and one yoke facing each of the pole pieces.

5. The actuator device for forced air supply according to claim 2 or 3,
wherein the magnetic circuits for said respective voice coils are formed by two magnets each provided with the pole piece on one side and two yokes facing the pole pieces individually.

6. The actuator device for forced air supply according to claim 1,
wherein said actuator device for forced air supply is structured as the air pump by means of repetitive and continuous oscillations of said diaphragms by forming the magnetic circuits by tensely providing said two diaphragms with said voice coils mounted on their outer surface sides to face each other within said housing, providing said magnets each provided with the pole piece on one side and said yokes which face the pole pieces with the magnetic gaps therebetween respectively on the outside of each of said diaphragms on both sides of said housing, and inserting said voice coils of said diaphragms into the magnetic gaps between the pole pieces and said yokes respectively and providing the current-carrying circuits of said voice coils to allow said two diaphragms to oscillate repetitively and continuously, providing the air inlet and outlet in said housing, and providing the on-off valve on the inside of said housing corresponding to the air inlet and the on-off valve on the outside of said housing corresponding to the air outlet.

7. A forced air supply-type air cell, being structured including the actuator device for forced air supply according to any one of claims 1 to 6.
